(19) United States
(12) Patent Application Publication
(10) Pub. No.: US 2015/0022113 A1
(43) Pub. Date: Jan. 22, 2015

(54) POWER FACTOR CONTROLLER BASED SINGLE-STAGE FLYBACK DRIVER AND LIGHT-EMITTING SYSTEM

(71) Applicant: OSRAM GmbH, Muenchen (DE)

(72) Inventors: Yewei Liufu, Shenzhen Guangdong (CN); Xuewei Dai, Shenzhen Guangdong (CN); XiHe Zhuang, Shenzhen Guangdong (CN); Quan Zhang, Shenzhen Guangdong (CN)

(73) Assignee: OSRAM GmbH, Muenchen (DE)

(21) Appl. No.: 14/370,492

(22) PCT Filed: Dec. 17, 2012
(86) PCT No.: PCT/EP2012/075751

§ 371 Date: Jul. 3, 2014

(30) Foreign Application Priority Data
Jan. 6, 2012 (CN) 201220005304.3

(51) Int. Cl. H05B 33/08; H02M 1/42; H02M 7/06

(52) U.S. Cl. CPC H05B 33/0815; H02M 7/06; H02M 1/42
USPC 315/247; 363/126

(57) ABSTRACT

Various embodiments relate to a power factor controller based single-stage flyback driver and a light-emitting system. The driver includes a primary-side circuit, a secondary-side circuit, a power factor controller, a current feedback circuit, a voltage feedback circuit, and a feedback signal generation circuit, wherein, in the secondary-side circuit, the output voltage is divided using a first voltage division resistor and a second voltage division resistor so as to provide the sampling of the output voltage to the voltage feedback circuit, and the first voltage division resistor or the second voltage division resistor is connected in parallel with a compensation branch having a capacitive reactance.

### RELATED APPLICATIONS

The present application is a national stage entry according to 35 U.S.C. §371 of PCT application No.: PCT/EP2012/075751 filed on Dec. 17, 2012, which claims priority from Chinese application No.: 201220005304.3 filed on Jan. 6, 2012, and is incorporated herein by reference in its entirety.

### TECHNICAL FIELD

Various embodiments relate to a driver and a light-emitting system using the driver, more specifically, to a power factor controller (PFC) based single-stage flyback driver which is used especially for driving a light-emitting diode (LED).

### BACKGROUND

For LEDs, the single-stage flyback driver is simple solution to high power factor and low bill of materials (BOM) cost. This solution may be implemented by using a PFC such as L6562 as a flyback controller. As a matter of course, this solution may also be used to provide a driver for other electrical devices.

### SUMMARY

However, the above driver has the overshoot problem at its startup, which is especially significant when the PFC used does not have the soft-start function. For LEDs, overshoot is dangerous and might damage the LED module.

Therefore, it is desired to optimize the output voltage Vout and output current lout at startup, in order to avoid overshoot at startup.

According to various embodiments, it is provided a power factor controller (PFC) based single-stage flyback driver, including: a primary-side circuit, configured to receive electricity from an alternating current (AC) power supply; a secondary-side circuit, configured to be coupled to a primary winding and supplies electricity to a load; a power factor controller (PFC), configured to control on and off of the primary-side circuit based on a feedback signal; a current feedback circuit, configured to control an output current of the driver based on a sampling of the output current and outputs a current feedback signal; a voltage feedback circuit, configured to control an output voltage of the driver based on a sampling of the output voltage and outputs a voltage feedback signal; and a feedback signal generation circuit, configured to provide a feedback signal to the PFC based on the current feedback signal from the current feedback circuit and the voltage feedback signal from the voltage feedback circuit. Specifically, in the secondary-side circuit, the output voltage is divided using a first voltage division resistor and a second voltage division resistor so as to provide the sampling of the output voltage to the voltage feedback circuit, and the first voltage division resistor or the second voltage division resistor is connected in parallel with a compensation branch having a capacitive reactance.

Preferably, the current feedback circuit includes a current error amplifier and a current feedback branch, specifically, a non-inverting input terminal of the current error amplifier is connected to a first reference voltage, an inverting input terminal of the current error amplifier is connected to a first comparison voltage, an output terminal of the current error amplifier is connected to the inverting input terminal of the current error amplifier via the current feedback branch, and the output terminal of the current error amplifier outputs the current feedback signal to the feedback signal generation circuit, the first comparison voltage being the sampling of the output current.

In addition, preferably, the voltage feedback circuit includes a voltage error amplifier and a voltage feedback branch, specifically, a non-inverting input terminal of the voltage error amplifier is connected to a second reference voltage, an inverting input terminal of the voltage error amplifier is connected to a second comparison voltage, an output terminal of the voltage error amplifier is connected to the inverting input terminal of the voltage error amplifier via the voltage feedback branch, and the output terminal of the voltage error amplifier outputs the voltage feedback signal to the feedback signal generation circuit, the second comparison voltage being the sampling of the output voltage.

The driver is configured preferably to drive a light-emitting diode (LED). In addition, the PFC is preferably a PFC without soft-start function, and more preferably an L6562.

Preferably, the compensation branch includes a compensation capacitor and a compensation resistor connected in series. Preferably, the compensation branch is configured so that the formed series branch has a time constant ranging from 1 to 1.2 times of an adjustment time, the adjustment time being the time from the moment the output current of the driver, if the driver does not have the compensation branch, reaches a rated current for the first time after startup to the moment the output current is substantially stable at the rated current.

According to various embodiments, it is also provided a light-emitting system including a plurality of light-emitting units, in which at least one of the light-emitting units includes an LED that is driven by the above driver.

By using the driver according to various embodiments, overshoot at startup is avoided. In addition, when the compensation branch includes a compensation capacitor and a compensation resistor, since capacitor and resistor components do not cost much, various embodiments provide the possibility of preventing overshoot without incurring almost any additional BOM cost.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is an overall configuration diagram of a PFC-based single-stage flyback driver;

FIG. 2A illustrates an exemplary configuration of a driver according to various embodiments;

FIG. 2B illustrates another exemplary configuration of a driver according to various embodiments;

FIGS. 3A and 3B illustrate the change at startup of the output voltage and output current of a driver without a compensation branch; and

FIGS. 3C and 3D illustrate the change at startup of the output voltage and output current of a driver with a compensation branch.

### DETAILED DESCRIPTION O

The following detailed description refers to the accompanying drawing that show, by way of illustration, specific details and embodiments in which the disclosure may be practiced.

According to an embodiment of the present disclosure, it is provided a power factor controller (PFC) based single-stage flyback driver, including: a primary-side circuit, configured to receive electricity from an alternating current (AC) power supply; a secondary-side circuit, configured to be coupled to a primary winding and supplies electricity to a load; a power factor controller (PFC), configured to control on and off of the primary-side circuit based on a feedback signal; a current feedback circuit, configured to control an output current of the driver based on a sampling of the output current and outputs a current feedback signal; a voltage feedback circuit, configured to control an output voltage of the driver based on a sampling of the output voltage and outputs a voltage feedback signal; and a feedback signal generation circuit, configured to provide a feedback signal to the PFC based on the current feedback signal from the current feedback circuit and the voltage feedback signal from the voltage feedback circuit. Specifically, in the secondary-side circuit, the output voltage is divided using a first voltage division resistor and a second voltage division resistor so as to provide the sampling of the output voltage to the voltage feedback circuit, and the first voltage division resistor or the second voltage division resistor is connected in parallel with a compensation branch having a capacitive reactance.

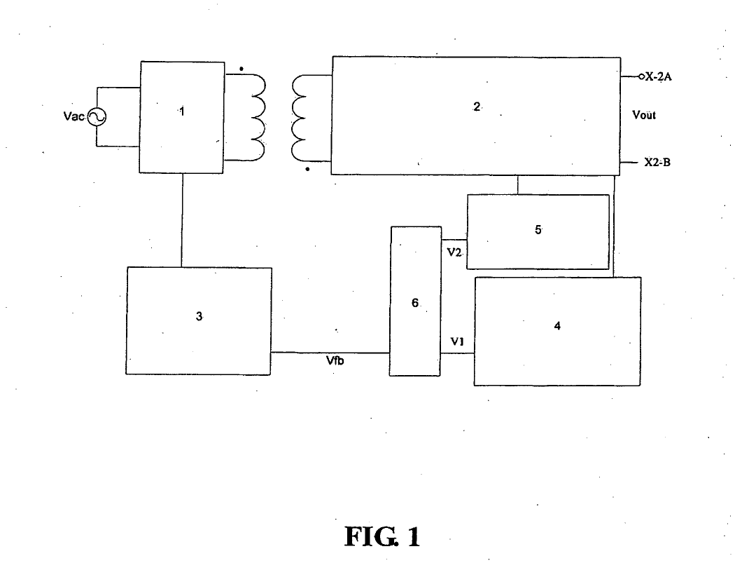

Exemplary configurations of the driver according to the embodiments of the present disclosure will be described in detail with reference to FIG. 1 to FIG. 3D.

As shown in FIG. 1, the overall configuration of a PFC-based single-stage flyback driver includes: a primary-side circuit (e.g., including a primary winding), a secondary-side circuit 2 (e.g., including a secondary winding), a PFC 3, a current feedback circuit 4, a voltage feedback circuit 5 and a feedback signal generation circuit 6.

The primary winding and the primary-side circuit are coupled to the secondary winding and the secondary-side circuit 3, specifically, the dotted terminals of the primary winding and the secondary winding are arranged close to each other. An external AC power supply Vac supplies electricity to the primary winding and the primary circuit 1.

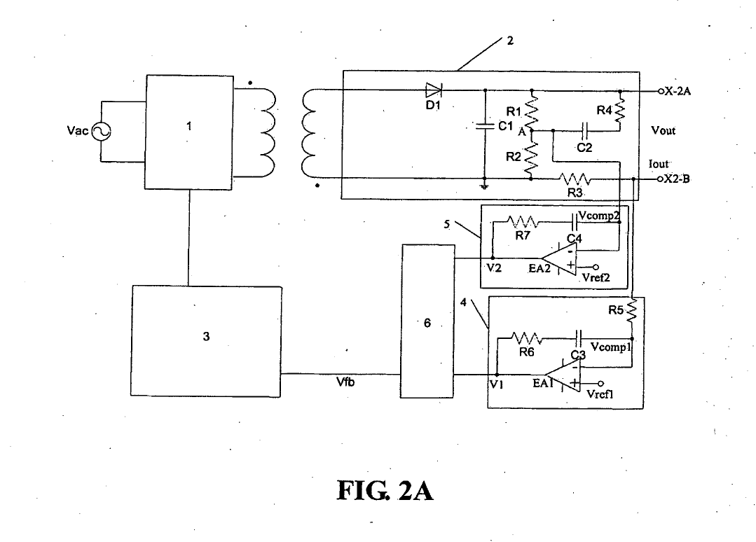

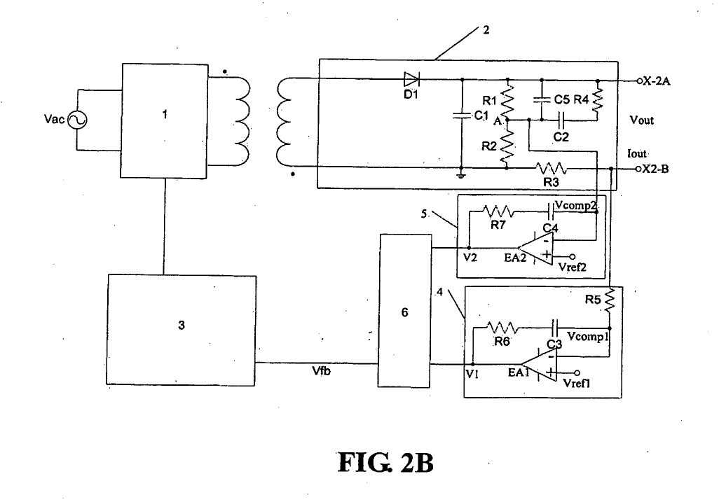

Specifically, as shown in FIG. 2A and FIG. 2B, when the primary winding and the primary-side circuit 1 are on, the magnetic field formed by the primary winding and the secondary winding stores energy, and an output filter capacitor C1 connected in series with a diode D1 supplies energy to a load (not shown) such as an LED; when the primary winding and the primary-side circuit 1 are off, the magnetic field formed by the primary winding and the secondary winding transmits the stored energy to the load and the output filter capacitor C1, to compensate for the consumption when the output filter capacitor C1 supplies energy to the load on its own. It is noted that according to design requirements or other factors, those skilled in the art may arrange the diode D1 and the output filter capacitor C1 in a way that is different from what is shown in FIG. 2A and FIG. 2B, or include additional diodes or capacitors.

A current feedback circuit 4 obtains a first comparison voltage Vcomp1 as a sampling of the output current Iout that passes through the load, by using a first current sampling resistor R3 and a second current sampling resistor R5. The first comparison voltage Vcomp1 is provided to an inverting input terminal of a current error amplifier EA1 in the current feedback circuit 4. A first reference Vref1 is provided to a non-inverting input terminal of the current error amplifier EA1. An output terminal of the current error amplifier EA1 is connected to the inverting input terminal of the current error amplifier EA1 via a current feedback branch. As shown in FIG. 2A and FIG. 2B, the current feedback branch includes a current feedback resistor R6 and a current feedback capacitor C3 connected in series. In addition, a voltage V1 at the output terminal of the current error amplifier EA1 is provided to a feedback signal generation circuit 6, as a current feedback signal. As a matter of course, according to design requirements or other factors, those skilled in the art may use other forms of the current feedback branch, or arrange the whole current feedback circuit 4 in other ways. The voltage feedback circuit 5 uses a second comparison voltage Vcomp2 at a junction A between a first voltage division resistor R1 and a second voltage division resistor R2 as a sampling of the output voltage Vout across the terminals (i.e., output terminals X-2A and X-2B) of the load (the voltage across the first voltage division resistor R1 and the second voltage division resistor R2 is considered roughly equal to the output voltage Vout because the resistance of the first current sampling resistor R3 is small). The second comparison voltage Vcomp2 is provided to an inverting input terminal of a voltage error amplifier EA2 in the voltage feedback circuit 5. A second reference voltage Vref 2 is provided to a non-inverting input terminal of the voltage error amplifier EA2. An output terminal of the voltage error amplifier EA2 is connected to the inverting input terminal of the voltage error amplifier EA2 via a voltage feedback branch. As shown in FIG. 2A and FIG. 2B, the voltage feedback branch includes a voltage feedback resistor R7 and a voltage feedback capacitor C4 connected in series. In addition, a voltage V2 at the output terminal of the voltage error amplifier EA2 is provided to the feedback signal generation circuit 6. As a matter of course, according to design requirements or other factors, those skilled in the art may use other forms of the voltage feedback branch, or arrange the whole voltage feedback circuit 5 in other ways.

When the driver operates in a constant current mode, the current feedback circuit 4 functions but the voltage feedback circuit 5 does not, making the output current lout constant. When the driver operates in a constant voltage mode, the voltage feedback circuit 5 functions but the current feedback circuit 4 does not, making the output voltage Vout constant. Detailed switching processes between the operations of the above current feedback circuit 4 and voltage feedback circuit 5 are omitted here since they are known to those skilled in the art.

The feedback signal generation circuit 6 receives the current feedback signal from the current feedback circuit 4 and the voltage feedback signal from the voltage feedback circuit 5, and provides a feedback signal to the PFC 3. The implementation method of this part is also known to those skilled in the art and therefore is omitted here.

The PFC 3 such as L6562 controls on and off of the primary winding and the primary-side circuit 1 based on the feedback signal from the feedback signal generation circuit 6, thereby realizing the function of the driver, i.e., converting the output of the AC power supply Vac into a DC output to drive the load. This process is also known to those skilled in the art and therefore is omitted here. It is noted that the PFC 3 may also be a PFC other than L6562, and preferably, preferably a PFC without soft-start function.

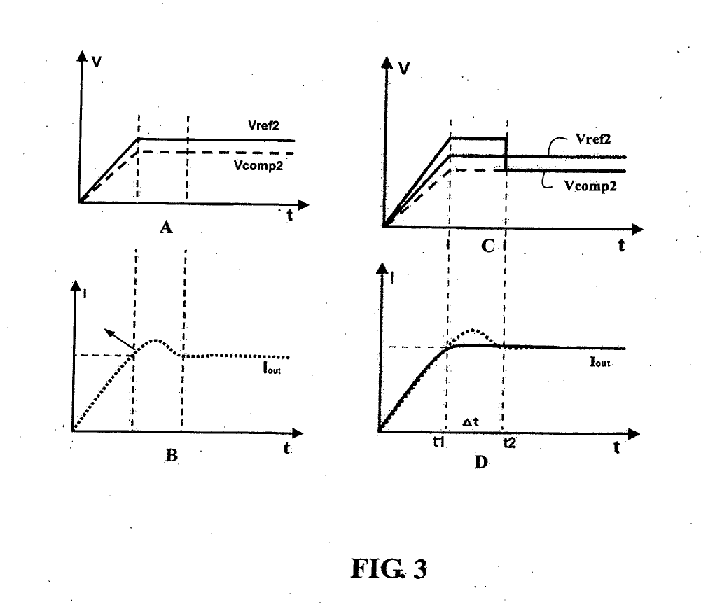

When the driver shown in FIG. 2A or FIG. 2B does not have the compensation branch consisting of a first compensation capacitor C2 and a compensation resistor R4, or the compensation branch consisting of the first compensation capacitor C2, a second compensation capacitor C5 and the compensation resistor R4, on startup of the driver, the output voltage Vout and the output current lout increase, and the second comparison voltage Vcomp2 and the first comparison voltage Vcomp1 increase correspondingly. In the beginning, the driver operates in a constant voltage mode, where the voltage feedback circuit 5 functions but the current feedback circuit 4 does not. As shown in FIG. 3A, by the voltage feedback circuit 5, the second comparison voltage Vcomp2 is limited to be below the second reference voltage Vref2 all the time. The solid line represents the second comparison voltage Vcomp2 and the dotted line represents the second reference voltage Vref2.

In this case, when the output voltage Vout is stable, the output current lout that passes through the load changes into a DC current, and the driver turns to operate in a constant current mode where the current feedback circuit 4 functions but the voltage feedback circuit 5 does not. Therefore, the adjustment of the output current lout is delayed in comparison with the adjustment of the output voltage Vout (i.e., the second comparison voltage Vcomp2), resulting in significant overshoot in lout as shown in FIG. 3B in which the dotted line represents the output current Iout. The overshoot in lout is especially significant when the PFC 3 does not have soft-start function.

As shown in FIG. 2A or FIG. 2B, when the driver has the compensation branch consisting of the first compensation capacitor C2 and the compensation resistor R4, or the compensation branch consisting of the first compensation capacitor C2, the second compensation capacitor C5 and the compensation resistor R4, on startup of the driver, the output voltage Vout and the output current lout increase, and the second comparison voltage Vcomp2 and the first comparison voltage Vcomp1 increase correspondingly. In the beginning, the driver operates in a constant voltage mode, where the voltage feedback circuit 5 functions but the current feedback circuit 4 does not. Due to the presence of the compensation branch, when the output voltage Vout increases, the second Vcomp2 increases faster than the second reference voltage Vref2, and will not be limited by the voltage feedback circuit 5 to be below the second reference voltage Vref2. Therefore, in the beginning, the second comparison voltage Vcomp2 is larger than the second reference voltage Vref2.

In this case, when the output current lout reaches a rated current, the second reference voltage Vref2 becomes stable, and thus the output voltage Vout stops increasing, instead, the output voltage Vout becomes a constant, making the AC component of the current that passes through the compensation branch decrease gradually to zero. Since the capacitive reactance component (e.g., the first compensation capacitor C2 and the second compensation capacitor C5) in the compensation branch is equivalently an open circuit with respect to a DC current, when the current that passes through the compensation branch becomes a DC current, the capacitive component in the compensation branch does not have any impact on the driver any more, which again limits the second comparison voltage Vcomp2 to be below the second reference voltage Vref2. This process is shown in FIG. 3C, in which the dotted lines represent the second comparison voltage Vcomp2 and the second reference voltage Vref2 respectively, and the dotted line represents the second comparison voltage of the driver without a compensation branch at startup.

In another aspect, when the output voltage Vout becomes a constant, since the driver is operating in a constant voltage mode, further increase of the output current lout is limited, thereby avoiding overshoot in the output current lout. When the current that passes through the compensation series branch becomes a DC current, the current that passes through the load also becomes a DC current and the driver turns to operate in a constant current mode where the current feedback circuit 4 functions but the voltage feedback circuit 5 does not. This process is shown in FIG. 3D, in which the solid line represents the output current lout having no overshoot, and the dotted line represents the output current of the driver without a compensation branch at startup, which shows significant overshoot.

Preferably, as shown in FIG. 2A, the compensation branch includes a compensation resistor R4 and a first compensation capacitor C2 connected in series, so that when the current that passes the compensation branch becomes a DC current, not only the capacitive component in the compensation branch does not have any impact on the driver any more, but also the non-capacitive and non-inductive component (e.g., the compensation resistor R4) of the compensation branch does not have any impact on the driver any more, due to its series connection to the capacitive component. In an alternative configuration of the compensation branch, a second compensation capacitor connected in parallel with the series of the compensation resistor R4 and the first compensation capacitor C3 may be included, as shown in FIG. 2B. In addition, despite of the presence of the compensation branch connected in parallel with the first voltage division resistor R1 in FIG. 2A and FIG. 2B, the compensation branch may also be connected in parallel with the second voltage division resistor R2. It is noted that although different configurations of the compensation branch are shown in FIG. 2A and FIG. 2B, those skilled in the art may use other forms of the compensation branch having a capacitive reactance according to design requirements or other factors.

To sum up, by arranging the compensation branch in the driver, overshoot at startup can be avoided. In addition, since the structure and configuration of the compensation branch is simple and cost little, almost no BOM cost and no manufacturing difficulty are increased.

Specific parameters of the compensation branch may be configured by those skilled in the art according to actual application situations. However, it is noticed by the present disclosure that a compensation branch with specific parameters according to the following technical solution may bring advantageous results, as shown in FIG. 3C and FIG. 3D.

When the compensation branch includes a compensation resistor R3 and a compensation capacitor C2 connected in series, assuming the resistance of the compensation resistor R4 is R and the capacitance of the compensation capacitor C2 is C, then the compensation branch has a time constant t=R*C. In addition, if it is assumed that the configuration and parameters of each of the other components are the same, the moment of the output current Iout of a traditional driver reaching the rated current for the first time after startup is t1, and the moment of the output current lout being substantially stable at the rated current is t2, then an adjustment time □t=t2−t1. Preferably, the time constant t of the compensation branch is configured to comply with Equation (1):

□t≦t≦1.2□t (1)

where “the moment of the output current lout being substantially stable at the rated current” refers to the moment during the process of the output current lout approaching the rated current when the difference between the output current lout and the rated current starts to be less than a predetermined difference. In the art, the moment is normally used as the moment the output current achieves stability.

In the embodiment, L6562 is used as an example of the PFC. However, it will be appreciated by those skilled in the art that other suitable PFCs, preferably, PFCs without soft-start function, may also be used.

In the embodiment, the driver is configured to drive an LED. However, it will be appreciated by those skilled in the art that the drive may also be used to drive other loads, especially some loads that have similar load characteristics to LEDs.

According to an embodiment of the present disclosure, it is also provided a light-emitting system including a plurality of light-emitting units, in which at least one of the light-emitting units includes an LED that is driven by the above driver. However, those skilled in the art may also apply the driver in other devices or systems.

In the specification, the relational terms such as “first” and “second” are merely used to distinguish an entity or operation from another entity or operation, without requiring or implying any actual relationship or sequence between the entities or operations. Moreover, the terms “include” and “comprise” and any other variants of them are inclusive, and do not exclude additional, unrecited elements of a process, method, product or device, as well as those elements that are inherently included by the process, method, product or device. Without further limitations, the wording “including an” element does not exclude the possibility of a plurality of the same elements present in the process, method, product or device including the element. The present disclosure and its advantages are described in detail, however, it will be appreciated that various variations, alternations and modifications may be made without deviation from the claims attached thereto. Moreover, the scope of the present application is not limited to the specific embodiments of the processes, devices, manufacture, and structures of materials, means, methods and steps described in the specification. Based on the disclosure of the present disclosure, those skilled in the art will understand that the present disclosure may be implemented with those processes, devices, manufacture, and structures of materials, means, methods or steps that are existing or to be developed in the future and that have the substantially same functions or the substantially same results as in the corresponding embodiments. Therefore, the attached claims should include the processes, devices, manufacture, and structures of materials, means, methods and steps.

The present disclosure is described above in the description with reference to specific embodiments. However, it will be appreciated that the embodiments described above are for illustrative purposes only and shall not limit the scope of the present disclosure. Those skilled in the art may make various modifications and variations without deviation from the essence and scope of the present disclosure. Therefore, the scope of the present disclosure shall be defined by only the attached claims and their equivalents.

1. A power factor controller (PFC) based single-stage flyback driver, comprising:
a primary-side circuit, configured to receive electricity from an alternating current (AC) power supply;
a secondary-side circuit, configured to be coupled to a primary winding and supplies electricity to a load;
a power factor controller (PFC), configured to control on and off of the primary-side circuit based on a feedback signal;
a current feedback circuit, configured to control an output current of the driver based on a sampling of the output current and outputs a current feedback signal;
a voltage feedback circuit, configured to control an output voltage of the driver based on a sampling of the output voltage and outputs a voltage feedback signal; and
a feedback signal generation circuit, configured to provide a feedback signal to the PFC based on the current feed-back signal from the current feedback circuit and the voltage feedback signal from the voltage feedback circuit,
wherein, in the secondary-side circuit, the output voltage is divided using a first voltage division resistor and a second voltage division resistor so as to provide the sampling of the output voltage to the voltage feedback circuit, and
the first voltage division resistor or the second voltage division resistor is connected in parallel with a compensation branch having a capacitive reactance.

2. The driver according to claim 1, wherein, the current feedback circuit comprises a current error amplifier and a current feedback branch, wherein a non-inverting input terminal of the current error amplifier is connected to a first reference voltage, an inverting input terminal of the current error amplifier is connected to a first comparison voltage, an output terminal of the current error amplifier is connected to the inverting input terminal of the current error amplifier via the current feedback branch, and the output terminal of the current error amplifier outputs the current feedback signal to the feedback signal generation circuit, the first comparison voltage being the sampling of the output current, and the voltage feedback circuit comprises a voltage error amplifier and a voltage feedback branch, wherein a non-inverting input terminal of the voltage error amplifier is connected to a second reference voltage, an inverting input terminal of the voltage error amplifier is connected to a second comparison voltage, an output terminal of the voltage error amplifier is connected to the inverting input terminal of the voltage error amplifier via the voltage feedback branch, and the output terminal of the voltage error amplifier outputs the voltage feedback signal to the feedback signal generation circuit, the second comparison voltage being the sampling of the output voltage.

3. The driver according to claim 1, wherein the driver is configured to drive a light-emitting diode (LED).

4. The driver according to claim 1, wherein the PFC does not have soft-start function.

5. The driver according to claim 4, wherein the PFC is an L6562.

6. The driver according to claim 1, wherein the compensation branch comprises a compensation capacitor and a compensation resistor connected in series.

7. The driver according to claim 1, wherein the compensation branch is configured so that the compensation branch has a time constant ranging from 1 to 1.2 times of an adjustment time, the adjustment time being the time from the moment the output current of the driver, if the driver does not have the compensation branch, reaches a rated current for the first time after startup to the moment the output current is substantially stable at the rated current.

8. A light-emitting system comprising a plurality of light-emitting units, wherein at least one of the light-emitting units comprises an LED that is driven by a driver
the driver comprising:
a primary-side circuit, configured to receive electricity from an alternating current (AC) power supply;
a secondary-side circuit, configured to be coupled to a primary winding and supplies electricity to a load;
a power factor controller (PFC), configured to control on and off of the primary-side circuit based on a feedback signal;
a current feedback circuit, configured to control an output current of the driver based on a sampling of the output current and outputs a current feedback signal;
a voltage feedback circuit configured to control an output voltage of the driver based on a sampling of the output voltage and outputs a voltage feedback signal; and
a feedback signal generation circuit, configured to provide a feedback signal to the PFC based on the current feed-back signal from the current feedback circuit and the voltage feedback signal from the voltage feedback circuit,
wherein, in the secondary-side circuit, the output voltage is divided using a first voltage division resistor and a second voltage division resistor so as to provide the sampling of the output voltage to the voltage feedback circuit, and
the first voltage division resistor or the second voltage division resistor is connected in parallel with a compensation branch having a capacitive reactance.
